(19) United States
(12) Patent Application Publication
(10) Pub. No.: US 2019/0351918 A1
(43) Pub. Date: Nov. 21, 2019

(54) ARTIFICIAL INTELLIGENCE APPARATUS FOR PROVIDING NOTIFICATION RELATED TO LANE-CHANGE OF VEHICLE AND METHOD FOR THE SAME

(71) Applicant: LG ELECTRONICS INC., Seoul (KR)

(72) Inventors: Jichan MAENG, Seoul (KR); Taehyun KIM, Seoul (KR); Beomoh KIM, Seoul (KR); Wonho SHIN, Seoul (KR)

(73) Assignee: LG ELECTRONICS INC., Seoul (KR)

(21) Appl. No.: 16/524,863

(22) Filed: Jul. 29, 2019

(30) Foreign Application Priority Data
Jun. 20, 2019 (KR) 10-2019-0073734

(51) Int. Cl. B60W 50/14; B60W 30/095; G08G 1/16

(52) U.S. Cl. CPC B60W 50/14; B60W 30/0953; B60W 30/0956; B60W 2540/18; B60W 2050/146; B60W 2520/10; G08G 1/167

(57) ABSTRACT

An AI apparatus for providing a notification related to a lane-change of a vehicle includes a sensor unit including at least one of an image sensor, a radar sensor or a LiDAR sensor, and a processor to receive, from the sensor unit, sensor information on a surrounding road and each of at least one external vehicle, to acquire first driving information including a position on the road, a velocity and a steering state with respect to the vehicle using the sensor information, to calculate second driving information including a position, a distance, and a velocity of each of the at least one external vehicle using the sensor information, to determine a lane-change suitability of a lane-change based on the first driving information and the second driving information, and to output a notification related to the lane-change based on the determined lane-change suitability.

### CROSS-REFERENCE TO RELATED APPLICATIONS

This application claims priority to Korean Patent Application No. 10-2019-0073734 filed on Jun. 20, 2019 in Korea, the entire contents of which is hereby incorporated by reference in its entirety.

### BACKGROUND

The present invention relates to an artificial intelligence (AI) apparatus, which provides a notification related to a lane-change of a vehicle, and a method for the same. In detail, the present invention relates to an AI apparatus, which is mounted inside a vehicle to determine the lane-change intention of the user, determines whether the lane-change is suitable, and provides a notification related to the lane-change when the lane-change is determined as being suitable, and a method for the same.

Recently, it is a tendency to provide a driving assist function that assists a driver in driving by using an AI technology for a vehicle, or to provide a self-driving function that replaces an operation for driving the driver. The driving assist function (or driving assist system) includes a cruise control function, a vehicle interval control function, or a lane keeping function. In addition, the self-driving function may include all driving assist functions.

In a real driving environment, a situation in which a vehicle changes a lane essentially occurs. When the vehicle changes the lane, there may be the higher risk that an accident occurs together with the running vehicle on a destination lane. Particularly, since the range of the lane that the driver on a driver's seat directly checks is limited and a blind spot exists in a visual field of the driver, the risk of the accident in the lane-change is much higher than other driving situations.

Therefore, if there is a function of safely guiding the lane-change when the vehicle changes the lane thereof, the risk of the accident during the driving may be significantly reduced.

### SUMMARY

The present invention is to provide an AI apparatus, which determines a lane-change intention, determines a lane-change suitability representing whether a lane-change is suitable, and provides a notification related to a lane-change based on the determined lane-change suitability, and a method for the same.

In addition, the present invention is to provide an AI apparatus, which outputs a guide image, through lighting, at a position, at which the vehicle is entered, of a target lane, and a method for the same.

Further, the present invention is to provide an AI apparatus, which provides a lane-change notification based on vehicle-to-vehicle communication to an adjacent vehicle to a target lane to be changed by the vehicle.

An embodiment of the present invention provides an AI apparatus, which determines a lane-change intention for a vehicle, determines a lane-change suitability and outputs a notification related to a lane-change based on the determined lane-change suitability, and a method for the same.

In addition, an embodiment of the present invention provides an AI apparatus, which determines a lane-change intention based on a velocity of a vehicle, a steering state of the vehicle, a position of the vehicle, a lighting state of a turn light of the vehicle, or an action of a driver, and a method for the same.

Further, an embodiment of the present invention provides an AI apparatus, which calculates an accident possibility based on driving information of a vehicle and driving information of an external vehicle, and determines a lane-change suitability based on the accident possibility.

In addition, an embodiment of the present invention provides an AI apparatus, which outputs a guide mage onto a road corresponding to a lane-change path or an arrival position by controlling an optical output module when the lane-change is suitable.

According to an embodiment of the present invention, the accident risk, which may occur during changing a lane, may be effectively reduced by providing a notification related to the lane-change based on the lane-change suitability when changing the lane change.

According to an embodiment of the present invention, the guide image is output through lighting at a position of the target lane which the vehicle enters, thereby notifying the movement of the vehicle to adjacent another vehicle as well as a driver of the relevant vehicle.

In addition, according to various embodiments of the present invention, the lane-change notification is provided to the adjacent vehicle on the target lane through the vehicle-to-vehicle communication, such that the adjacent vehicle copes with the lane-change in advance.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 is a block diagram illustrating an AI apparatus according to an embodiment of the present invention.

FIG. 2 is a block diagram illustrating an AI server according to an embodiment of the present invention.

FIG. 3 is a diagram illustrating an AI system according to an embodiment of the present invention.

FIG. 4 is a block diagram illustrating an AI apparatus according to an embodiment of the present invention.

FIGS. 5 and 6 are block diagrams illustrating AI systems according to an embodiment of the present invention.

FIG. 7 is a flowchart illustrating a method for providing a notification associated with a lane-change of a vehicle according to an embodiment of the present invention.

FIG. 8 is a flowchart illustrating an example of the step S705 of determining a lane-change intention for a vehicle illustrated in FIG. 7.

FIG. 9 is a diagram illustrating a process of monitoring the state of a driver according to an embodiment of the present invention.

FIG. 10 is a diagram illustrating a method for providing a notification related to a lane-change when the lane-change is unsuitable according to an embodiment of the present invention.

FIG. 11 is a diagram illustrating a method for providing a notification related to a lane-change when the lane-change is suitable according to an embodiment of the present invention.

FIGS. 12 to 14 are diagrams illustrating a method for providing a notification related to a lane-change when the lane-change is suitable according to an embodiment of the present invention.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the invention in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for training data is given, and the label may mean the correct answer (or result value) that the artificial neural network must infer when the training data is input to the artificial neural network. The unsupervised learning may refer to a method of learning an artificial neural network in a state in which a label for training data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

### eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

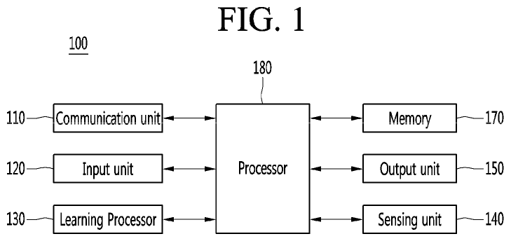

FIG. 1 is a block diagram illustrating an AI apparatus 100 according to an embodiment of the present invention.

The AI apparatus (or an AI device) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI apparatus 100 may include a communication unit 110, an input unit 120, a learning processor 130, a sensing unit 140, an output unit 150, a memory 170, and a processor 180.

The communication unit 110 may transmit and receive data to and from external devices such as other AI apparatuses 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a training data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using training data. The learned artificial neural network may be referred to as a learning model. The learning model may be used to an infer result value for new input data rather than training data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI apparatus 100. Alternatively, the learning processor 130 may be implemented by using the memory 170, an external memory directly connected to the AI apparatus 100, or a memory held in an external device.

The sensing unit 140 may acquire at least one of internal information about the AI apparatus 100, ambient environment information about the AI apparatus 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI apparatus 100. For example, the memory 170 may store input data acquired by the input unit 120, training data, a learning model, a learning history, and the like.

The processor 180 may determine at least one executable operation of the AI apparatus 100 based on information determined or generated by using a data analysis algorithm or a machine learning algorithm. The processor 180 may control the components of the AI apparatus 100 to execute the determined operation.

To this end, the processor 180 may request, search, receive, or utilize data of the learning processor 130 or the memory 170. The processor 180 may control the components of the AI apparatus 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI apparatus 100 so as to drive an application program stored in memory 170. Furthermore, the processor 180 may operate two or more of the components included in the AI apparatus 100 in combination so as to drive the application program.

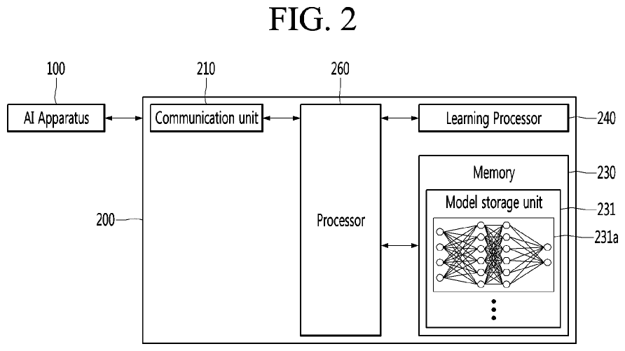

FIG. 2 is a block diagram illustrating an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI apparatus 100, and may perform at least part of the AI processing together.

The AI server 200 may include a communication unit 210, a memory 230, a learning processor 240, a processor 260, and the like.

The communication unit 210 can transmit and receive data to and from an external device such as the AI apparatus 100.

The memory 230 may include a model storage unit 231. The model storage unit 231 may store a learning or learned model (or an artificial neural network 231a) through the learning processor 240.

The learning processor 240 may learn the artificial neural network 231a by using the training data. The learning model may be used in a state of being mounted on the AI server 200 of the artificial neural network, or may be used in a state of being mounted on an external device such as the AI apparatus 100.

The learning model may be implemented in hardware, software, or a combination of hardware and software. If all or a part of the learning models is implemented in software, one or more instructions that constitute the learning model may be stored in memory 230.

The processor 260 may infer the result value for new input data by using the learning model and may generate a response or a control command based on the inferred result value.

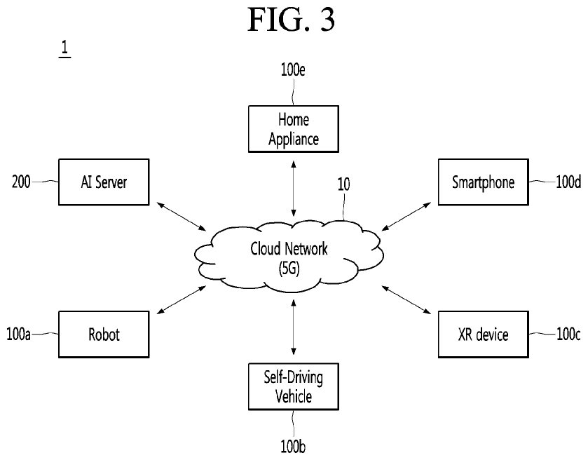

FIG. 3 is a diagram illustrating an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI apparatuses 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI apparatuses constituting the AI system 1, that is, the robot 100a, the self-driving vehicle 100b, the XR device 100c, the smartphone 100d, or the home appliance 100e through the cloud network 10, and may assist at least part of AI processing of the connected AI apparatuses 100a to 100e.

At this time, the AI server 200 may learn the artificial neural network according to the machine learning algorithm instead of the AI apparatuses 100a to 100e, and may directly store the learning model or transmit the learning model to the AI apparatuses 100a to 100e.

At this time, the AI server 200 may receive input data from the AI apparatuses 100a to 100e, may infer the result value for the received input data by using the learning model, may generate a response or a control command based on the inferred result value, and may transmit the response or the control command to the AI apparatuses 100a to 100e.

Alternatively, the AI apparatuses 100a to 100e may infer the result value for the input data by directly using the learning model, and may generate the response or the control command based on the inference result.

Hereinafter, various embodiments of the AI apparatuses 100a to 100e to which the above-described technology is applied will be described. The AI apparatuses 100a to 100e illustrated in FIG. 3 may be regarded as a specific embodiment of the AI apparatus 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

### AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the LiDAR, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

### AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

### AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

### AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

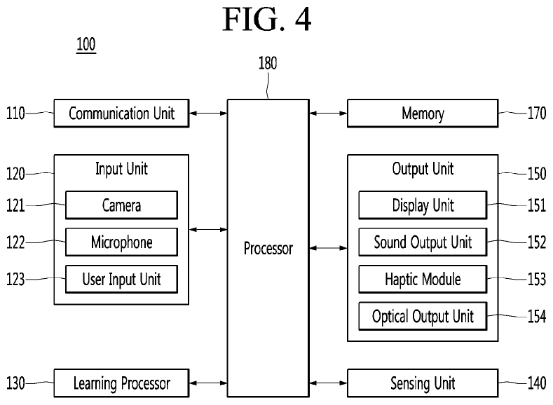

FIG. 4 is a block diagram illustrating an AI apparatus according to an embodiment of the present invention.

The redundant repeat of FIG. 1 will be omitted below.

Referring to FIG. 4, the input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the mobile terminal 100 may include at least one camera 121 in order for inputting image information.

The camera 121 processes image frames such as a still image or a video obtained by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the AI apparatus 100. Moreover, various noise canceling algorithms for removing noise occurring during the reception of external sound signals may be implemented in the microphone 122.

The user input unit 123 is to receive information from a user and when information is inputted through the user input unit 123, the processor 180 may control an operation of the AI apparatus 100 to correspond to the inputted information.

The user input unit 123 may include a mechanical input means (or a mechanical key, for example, a button, a dome switch, a jog wheel, and a jog switch at the front, back or side of the AI apparatus 100) and a touch type input means. As one example, a touch type input means may include a virtual key, a soft key, or a visual key, which is displayed on a touch screen through software processing or may include a touch key disposed at a portion other than the touch screen.

A sensing unit 140 may be called a sensor unit.

The output unit 150 may include at least one of a display unit 151, a sound output module 152, a haptic module 153, or an optical output module 154.

The display unit 151 may display (output) information processed in the AI apparatus 100. For example, the display unit 151 may display execution screen information of an application program running on the AI apparatus 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the AI apparatus 100 and a user, and an output interface between the AI apparatus 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the AI apparatus 100. An example of an event occurring in the AI apparatus 100 includes message reception, call signal reception, missed calls, alarm, schedule notification, e-mail reception, and information reception through an application.

The optical output module 154 may include various light sources such as LEDs and lasers, and may be referred to as a lighting unit.

In this case, the optical output module 154 may include a driving unit capable of adjusting the size and direction of the emitting light, or may be connected to the driving unit.

In this case, the optical output module 154 may include a projector, and may output an image by projecting light.

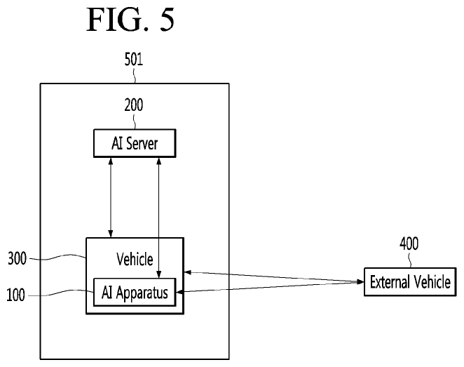

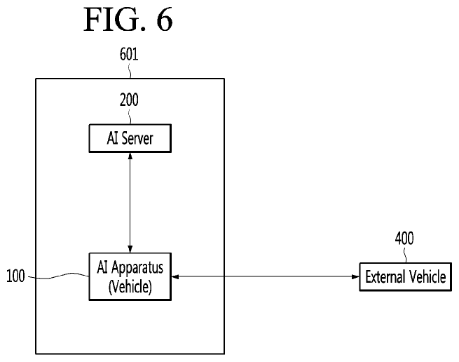

FIGS. 5 and 6 are block diagrams illustrating AI systems according to an embodiment of the present invention.

Referring to FIGS. 5 and 6, an AI system 501 (or 601) to determine the position of a user may include at least one of an AI apparatus (or AI device) 100, an AI server 200, or a vehicle 300.

In the AI system 501 of FIG. 5, the AI apparatus 100 is separated from the vehicle 300, and is mounted in the vehicle 300. In other words, the AI apparatus 100 may be mounted in a typical vehicle or a vehicle equipped with an AI function to provide a notification related to a lane-change.

In this case, the AI apparatus 100 may be implemented in the form of a module to be mounted in the vehicle 300.

In the AI system of FIG. 6, the AI apparatus 100 may be integrated with the vehicle in the form of one component, and the vehicle equipped with the AI function may be referred to as the AI apparatus 100.

In other words, the vehicle according to the present invention refers to a target to be controlled by the AI apparatus 100 or a target to be provided with a function by the AI apparatus 100.

The AI apparatus 100, the AI server 200, and the vehicle 300 may make communication with each other through a wireless or wireless communication technology.

In this case, the AI apparatus 100, the AI server 200, and the vehicle 300 may make communication with each other through a base station or a router, or may make direct communication with each other using a short-range wireless communication technology.

For example, the AI apparatus 100, the AI server 200, and the vehicle 300 may make communication with each other directly or through a base station based on fifth generation (5G) communication.

The AI apparatus 100 and the vehicle 300 may make communication with the external vehicle 400 through a wired/wireless communication technology.

In this case, the AI apparatus 100 and the vehicle 300 may make communication with the external vehicle 400 depending on vehicle to vehicle (V2V) or vehicle to everything (V2X).

In this case, the AI apparatus 100 and the vehicle 300 may make communication with the external vehicle 400 directly or through a base station based on 5G communication.

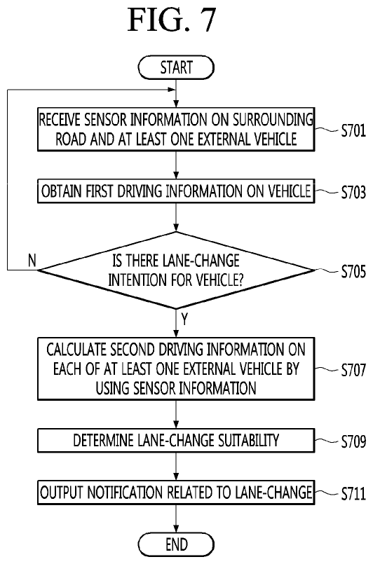

FIG. 7 is a flowchart illustrating a method for providing a notification associated with a lane-change of a vehicle according to an embodiment of the present invention.

Referring to FIG. 7, a processor 180 of the AI apparatus 100 receives sensor information on a surrounding road and at least one external vehicle (S701).

In this case, the vehicle indicates a target controlled by the AI apparatus 100 as described with reference to FIGS. 5 and 6.

When the AI apparatus 100 refers to the vehicle, the vehicle is the AI apparatus 100 itself. When the AI apparatus 100 is a component distinguished from the vehicle, the AI apparatus 100 is a device mounted in the vehicle to control the vehicle or to assist the function of the vehicle.

Hereinafter, a vehicle changing a lane and controlled by the AI apparatus 100 will be referred to as a vehicle or an AI vehicle regardless of the AI apparatus 100 itself or a component separated from the AI apparatus 100. In other words, the vehicle may indicate the AI apparatus 100 itself.

The processor 180 may receive sensor information collected by the sensor unit 140.

As described above, the sensor unit 140 may include at least one of an image sensor, a radar sensor, or a LiDAR sensor. Accordingly, the sensor information collected by the sensor unit 140 may include RGB image data, depth image data, distance information to an object, or directional information of the object.

The sensor information includes data obtained by sensing a surrounding road of the vehicle and data obtained by sensing at least one or more external vehicles.

The processor 180 may receive sensor information on the surrounding road from sensors installed in a front portion of the vehicle.

The processor 180 may receive sensor information on each of at least one or more external vehicles from sensors installed on the side, a rear portion, or a side-rear portion of the vehicle.

In addition, the processor 180 of the AI apparatus 100 obtains the first driving information on the vehicle (S703).

The first driving information on the vehicle may include at least one of the position of the vehicle on the road, the velocity of the vehicle, the acceleration of the vehicle, or the steering condition of the vehicle.

The processor 180 may receive the first driving information such as the velocity of the vehicle, the acceleration of the vehicle, or the steering state of the vehicle from an electronic control unit (ECU) of the vehicle.

The velocity is a vector containing information on a speed and a direction.

The processor 180 may recognize a lane on the road on which the vehicle is running, based on sensor information, and may determine the position of the vehicle on the road based on the lane, thereby obtaining the first driving information.

Then, the processor 180 of the AI apparatus 100 determines the lane-change intention for the vehicle (S705).

The determining of the lane-change intention for the vehicle in step S705 may refer to determine whether there is the lane-change intention for the vehicle.

The processor 180 may determine, through a self-driving function or a driving assist function for the vehicle, whether there is the lane-change intention for the vehicle, based on whether a control signal or a lane-change command, which is to change the lane, is generated from the processor 180, the ECU, or other control devices (e.g., a self-driving control unit) without an input of a user.

For example, when the self-driving control unit generates the control signal to change the lane, the processor 180 may determine that there is the lane-change intention for the vehicle.

The processor 180 may determine whether a driver has an intention to change a lane, based on the behavior of the driver (or the user) or the vehicle handling of the driver.

For example, when behavior of the driver for the lane-change, such as manipulating a turn light, viewing a side window, a side-view mirror (or a rear-view mirror), or a room mirror more than usual, or handling a steering wheel toward another lane, is recognized, the processor 180 may determine that there is the lane-change intention for the vehicle.

In this case, the processor 180 may obtain image data including the face of the driver from the camera 121 and may obtain the state information of the driver, which includes a gaze direction, a head direction, or a drowsy driving state of the driver, based on the obtained image data.

For example, the processor 180 may determine whether the driver is drowsing, from the image data, and may determine that there is no lane-change intention for the vehicle by the driver if it is determined that the driver is drowsing.

The lane-change intention for the vehicle by the driver indicates whether the driver has an intention to personally change the lane, and is an expression to distinguish from a lane-change intention through a self-driving function of the vehicle.

In other words, even if it is determined that the driver is drowsing, when the self-driving function is currently activated in the vehicle, and the self-driving function attempts to change the lane for the vehicle, the processor 180 may determine that there is the lane-change intention.

When the user uses a separate navigation terminal, or uses a navigation function installed in a vehicle, the processor 180 may determine whether there is a lane-change intention, based on path information provided from the navigation system.

For example, when information for changing a lane in which the vehicle is currently running is included in the path information provided from the navigation system, the processor 180 may determine whether there is the lane-change intention, based additionally on the information. In other words, in the situation that the navigation system gives information of changing a present lane to a specific lane, while the driver looks at the direction of the specific lane or handles a steering wheel toward the specific lane, the processor 180 may determine that there is the lane-change intention.

When there is no lane-change intention as the determination result of step S705, the processor 180 returns to step S701 of receiving sensor information.

Then, the processor 180 of the AI apparatus 100 calculates second driving information on each of at least one external vehicle by using sensor information (S707).

The second driving information on each of at least one external vehicle may include the position of each external vehicle, the distance to the external vehicle, or the velocity of the external vehicle.

The processor 180 may recognize external vehicles based on the sensor information obtained from the camera or the image sensor.

In this case, the processor 180 may recognize and identify the external vehicles using the vehicle recognition model, and the vehicle recognition model may be a model based on an artificial neural network learned using the machine learning algorithm or the deep learning algorithm.

The vehicle recognition model may be learned by a learning processor 130 of the AI apparatus 100 or by a learning processor 240 of the AI server 200. In addition, the processor 180 may recognize external vehicles by directly using the vehicle recognition model stored in the memory 170 or may receive recognition information of the external vehicle recognized using the vehicle recognition model from the AI server 200 as the sensor information is transmitted to the AI server 200.

The processor 180 may calculate the directions of external vehicles and the distance to the external vehicles based on the sensor information obtained from a LiDAR sensor or a radar sensor. In addition, the processor 180 may determine the position of the external vehicle relatively to a present vehicle, based on the directions of the external vehicles and the distances to the external vehicles.

The processor 180 may calculate the velocity of each external vehicle by using the position information and the distance information on each external vehicle.

Accordingly, the processor 180 may calculate the position, the distance, and the velocity with respect to each external vehicle by using the sensor information.

The processor 180 may receive at least a part of the second driving information on the external vehicle through the V2X communication with the external vehicles using the communication unit 110.

For example, the processor 180 may make direct communication with the external vehicle through the communication unit 110, and may receive driving information such as the position or the velocity of the vehicle from the external vehicle.

The position information of each vehicle is a position on the road, which may indicate a lane number at which the vehicle is positioned, a position of the vehicle relatively to the lane, and may indicate a geographical position through a global positioning system (GPS) in a macroscopic viewpoint

For example, the processor 180 may calculate the distance between the (AI) vehicle and the external vehicle, as the difference value between the positions of the two vehicles on the GPS.

Then, the processor 180 of the AI apparatus 100 determines the lane-change suitability (S709).

The lane-change suitability may indicate whether an accident will occur when the vehicle changes a lane based on the lane-change intention.

The processor 180 may calculate an accident possibility with each external vehicle if the lane is changed based on the first driving information and the second driving information, and determine the lane-change suitability, based on whether the calculated accident possibility exceeds a preset reference value.

The first driving information is information indicating the driving state of the AI vehicle, and the second driving information is information indicating the driving state of each of the external vehicles. Accordingly, the accident possibility between the AI vehicle and the external vehicle can be determined by using the first driving information and the second driving information.

In this case, the accident possibility may refer to vehicle collision/clash possibility.

The processor 180 may calculate the accident possibility in the lane-change, with respect to each external vehicle, and may determine the lane-change suitability based on the accident possibility having the largest value.

For example, when the processor 180 recognizes four external vehicles and calculates the accident possibility in the lane-change to 1%, 5%, 2%, and 10% for each of the respective external vehicles, the processor 180 may determine the lane-change suitability by comparing 10%, which is the largest accident possibility, with a reference value.

In this case, the accident possibility may be calculated by using an accident possibility calculation model, and the accident possibility calculation module may include a regression model or an artificial neural network model.

In this case, the accident possibility may be calculated based on the velocity of the AI vehicle, the steering state of the AI vehicle, the distance to the external vehicle, the velocity of the external vehicle, or the position of the external vehicle.

The processor 180 may calculate the accident possibility by making a weighted sum of the distance to the external vehicle, the velocity of the external vehicle, and the position of the external vehicle based on preset weights, or may calculate the accident possibility based on a function of calculating the accident possibility.

Alternatively, the processor 180 may directly determine the lane-change suitability based on the distance to the external vehicle, the velocity of the external vehicle, and the position of the external vehicle.

For example, the processor 180 may determine the lane-change as being unsuitable when the distance to the external vehicle is lower than a first reference value, and the distance to the external vehicle is greater than the first reference value and smaller than the second reference value, but when the velocity of the external vehicle is greater than the third reference value.

In other words, since the distance to the external vehicle and the velocity of the external vehicle are not mutually independent factors, the processor 180 may integrally consider the distance to the external vehicle and the velocity of the external vehicle to determine the lane-change suitability.

In addition, the processor 180 may determine the lane-change path of the vehicle in the lane-change and the arrival position in a destination lane, based on the first driving information.

In detail, the processor 180 may determine the lane-change path and the arrival position based on the present velocity of a vehicle, the present position of the vehicle on the road, and the present steering state of the vehicle.

Further, the processor 180 may determine the destination lane based on a lighting state of a turn light of the vehicle or the gaze direction of the driver, and may determine the lane-change path and the arrival position based on the determination.

In this case, the processor 180 may determine the lane-change path and the arrival position by using a path prediction model, and the path prediction model is an artificial neural network-based model which is learned by using a machine learning algorithm or a deep learning algorithm.

The path prediction model may be learned by the learning processor 130 of the AI apparatus 100 or by the learning processor 240 of the AI server 200. In addition, the processor 180 may determine the lane-change path and the arrival position by directly using the path prediction model stored in the memory 170, and may receive the lane-change path and the arrival position determined using the path prediction model from the AI server 200 as the first driving information is transmitted to the AI server 200.

Then, the processor 180 of the AI apparatus 100 may output a notification related to the lane-change based on the lane-change suitability (S711).

When the lane-change is determined as being unsuitable, the processor 180 may output a notification or a warning that the lane-change is unsuitable.

The notification related to the lane-change may be output in various forms.

The processor 180 may output a guide, which serves as a notification related to the lane-change, in the form of an image through the display unit 151, in the form of a sound through the sound output module 152, in the form of a vibration through the haptic module 153.

The processor 180 may output the warning of notifying that the lane-change is unsuitable, through a head up display (HUD) of the vehicle.

To the contrary, when the lane-change is determined as being suitable, the processor 180 may output a notification related to the lane-change, which notifies the lane-change of the vehicle.

The processor 180 may output a guide image for notifying the lane-change on the road corresponding to the lane-change path or the arrival position by controlling the optical output module 154 capable of adjusting the direction and the size of light which is projected.

In this case, the guide image may be a preset vehicle image corresponding to the size and the type of the vehicle.

In this case, the processor 180 may output the guide image at the arrival position of the vehicle or output the guide image in the form of an animation moving along the lane-change path by controlling the optical output module 154.

In addition, when the lane-change is determined as being suitable, the processor 180 may transmit a notification of a lane-change to external vehicles through the communication unit 110. In other words, the processor 180 may provide the notification of the lane-change to the external vehicle through V2X or V2V.

In this case, the processor 180 may transmit, through the communication unit 110, the notification of the lane-change to at least one of adjacent vehicles, which are within a predetermined distance from the vehicle, of the external vehicles.

This is necessary to solve the problem of providing an unnecessary notification to external vehicles at a remote place when the notification of the lane-change is provided to all external vehicles.

Accordingly, the processor 180 may provide the notification of the lane-change only to the adjacent vehicles, which are within the predetermined distance from the vehicle, of the external vehicles.

In this case, the processor 180 may provide the notification of the lane-change only to the adjacent vehicles, which are within the predetermined distance from the vehicle, by comparing GPS information of a present vehicle and GPS information of the external vehicles.

As described above, the notification of the lane-change is output to the inner part of the vehicle, the external vehicle, or a road outside the vehicle, thereby ensuring the safety in lane-change.

In addition, when the notification of the lane-change is used in a link to a rear-side warning device, the safety in lane-change may be more enhanced.

Further, even when the notification of the lane-change is applied to the self-driving function, the safer lane-change is possible.

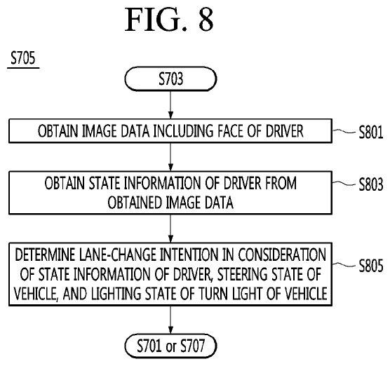

FIG. 8 is a flowchart illustrating an example of the step S705 of determining a lane-change intention for a vehicle illustrated in FIG. 7.

Referring to FIG. 8, the camera 121 of the AI apparatus 100 obtains image data including the face of the driver (S801).

The camera 121 may be installed in a direction of facing the driver in front of the driver so as to obtain the image data including the image data on the face of the driver.

For example, the camera 121 may be installed at a position such as a steering wheel, a dashboard, a room mirror, or a front ceiling.

Then, the processor 180 of the AI apparatus 100 may obtain the state information of the driver, which includes a gaze direction, a head direction, or a drowsy driving state of the driver, based on the obtained image data (S803).

The processor 180 may determine the drowsy driving state of the driver in consideration of the frequency at which the driver blinks the eyes, whether the driver closes the eyes, the time during which the driver closes the eyes, and the frequency of yawning.

At this time, the processor 180 may determine the head direction, the gaze direction, or the drowsy driving state of the driver by using an eye recognition model or a gaze recognition model learned by using a machine learning algorithm or a deep learning algorithm.

As described above, the obtaining of the state information of the driver by obtaining the image data including the face of the driver may be referred to as Driver Status Monitoring (DSM).

Then, the processor 180 of the AI apparatus 100 determines the lane-change intention in consideration of the state information of the driver, the steering state of the vehicle, and the lighting state of the turn light of the vehicle (S805).

In this case, the processor 180 may determine the lane-change intention for the vehicle using a lane-change intention determination model learned by using the machine learning algorithm or the deep learning algorithm.

For example, the lane-change intention determination model includes an artificial neural network, and is a model to output whether there is the lane-change intention, when an input feature vector including at least one of the gaze direction of the driver, the head direction of the driver, the time during which the driver closes the eyes, and the frequency of yawning, the steering state of the vehicle, or the lighting state of the turn light of the vehicle is inputted.

In this case, the lane-change intention determination model may be learned by using training data labeled with whether there is the lane-change intention.

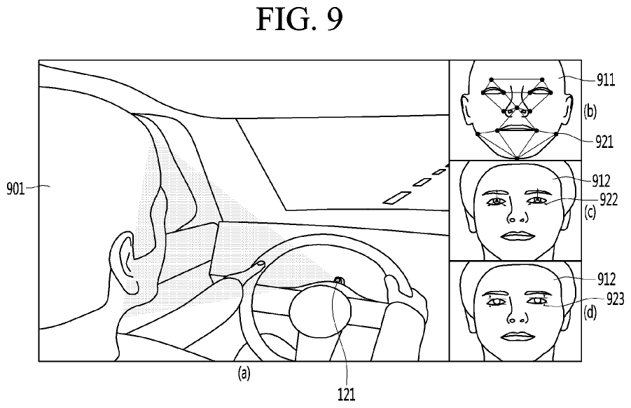

FIG. 9 is a diagram illustrating a process of monitoring the state of a driver according to an embodiment of the present invention.

Referring to FIG. 9(a), the processor 180 may obtain image data 911 and 912 including the face of a driver 901 through a camera 121 installed inside a vehicle.

In this case, the processor 180 may obtain various types of image data depending on the type of the camera 121.

For example, the processor 180 may obtain depth image data 911 using a depth camera, and may obtain RGB image data 912 using a typical RGB camera.

Referring to FIG. 9(b), the processor 180 may extract features from the face of the driver 901 from depth image data 911 to recognize the face (921).

Then, the processor 180 may identify a plurality of drivers by distinguishing between the plurality of drivers, determine the head direction of the driver, or determine whether the user is opening the mouth of the user, through the face recognition.

Referring to FIG. 9(c), the processor 180 may recognize the eyes of the driver 901 from the RGB image data 912 (922).

In this case, the recognizing of the eyes (922) may include recognizing the gaze direction.

Referring to FIG. 9(d), the processor 180 may recognize whether the driver 901 closes the eyes, or recognize eyelids of the driver from the RGB image data 912 (923).

In this case, the recognizing 923 of whether the driver closes the eyes may be determined by measuring the distance between the eyelids, or by determining whether the eyeball is not recognized at the position of the eyeball.

In other words, the processor 180 may distinguish the drivers from each other and determine whether the driver is yawning by recognizing the face of the driver 901. Also, the processor 180 may determine whether the driver 901 gazes the side window, the side mirror or the room mirror by recognizing the eyeballs of the driver 901. Also, the processor 180 may determine whether the driver 901 is drowsing by recognizing the eyelid of the user 901.

Then, the processor 180 may use the recognized information to determine whether the driver has the lane-change intention.

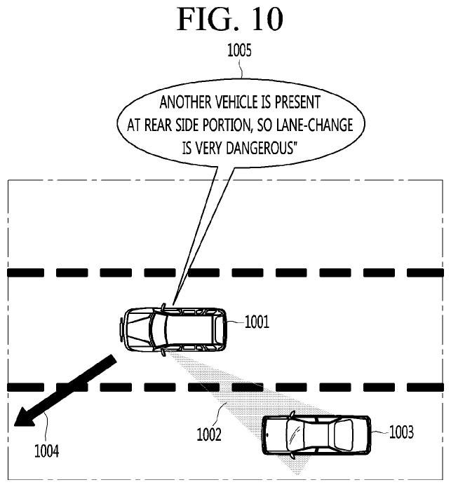

FIG. 10 is a diagram illustrating a method for providing a notification related to a lane-change when the lane-change is unsuitable according to an embodiment of the present invention.

There is a blind spot 1002 around a vehicle 1001, which is not recognized by a driver. In addition, as illustrated in FIG. 10, when an external vehicle 1003 is positioned in the blind spot 1002, it is difficult for the driver of the vehicle 1001 to recognize the external vehicle 1003.

In this case, when the processor 180 determines that there is the lane-change intention for the vehicle 1001 to change a lane to the left, the processor 180 may determine that the lane-change is unsuitable because an external vehicle 1003 is driving in the blind spot 1002.

Then, the processor 180 may output a warning or a notification that “another vehicle is present at the rear side portion, so the lane-change is very dangerous”, through a speaker or a sound output module (1005).

Alternatively, the processor 180 may output, through the display unit, the notification or the warning that the lane-change is dangerous.

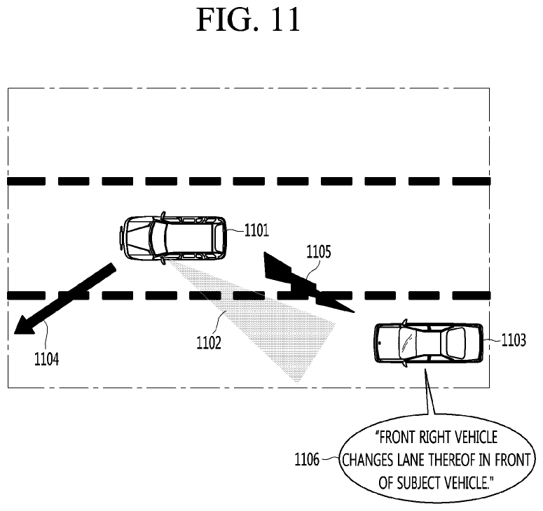

FIG. 11 is a diagram illustrating a method for providing a notification related to a lane-change when the lane-change is suitable according to an embodiment of the present invention.

Referring to FIG. 11, the external vehicle 1103 is driving outside the blind spot 1102 of the AI vehicle 1101.

In this case, when the processor 180 determines that there is a lane-change intention for the vehicle 1101 to change the lane to the left (1104), the processor 180 may determine that the lane-change is suitable because the accident possibility with the external vehicle 1103 is low.

In addition, the processor 180 may transmit, to the external vehicle 1103, a sound output signal for outputting sound notification on the lane-change through the V2X or V2V (1105), and the external vehicle 1103 may output a notification such as “a front right vehicle changes the lane thereof in front of the subject vehicle.” through a speaker or a sound output module based on the sound output signal received therein (1106).

Alternatively, the processor 180 may transmit an image output signal to output an image notification of a lane-change to the external vehicle 1103 through the V2X or V2V (1105), and the external vehicle 1103 may output a notification of a lane-change through the display unit based on the received image output signal.

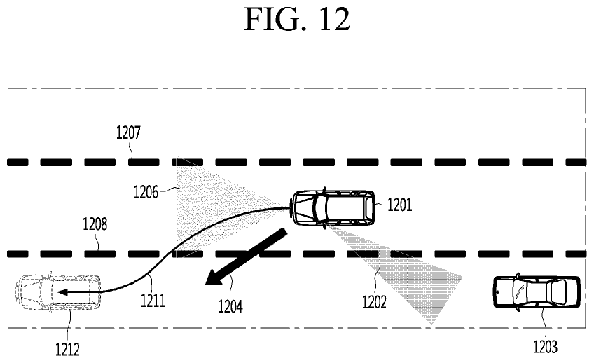

FIGS. 12 to 14 are diagrams illustrating a method for providing a notification related to a lane-change when the lane-change is suitable according to an embodiment of the present invention.

Referring to FIGS. 12 to 14, an external vehicle 1203 is driving outside a blind spot 1202 of an AI vehicle 1201.

In this case, when the processor 180 determines that there is a lane-change intention for the vehicle 1201 to change the lane to the left (1204), the processor 180 may determine that the lane-change is suitable because the accident possibility with the external vehicle 1203 is low.

As illustrated in FIG. 12, the processor 180 may obtain image data 1206 for a forward road from a camera or image sensor installed in front of the vehicle 1201 (1206), may recognize lanes 1207 and 1208 of the forward road based on the obtained image data, and may determine the position of the vehicle 1201 on the road.

In addition, the processor 180 may then determine a lane-change path 1211 and an arrival position 1212 of the vehicle 1201 based on the first driving information for the vehicle 1201.

As described above, the first driving information may include a velocity of the vehicle 1201, an acceleration of the vehicle 1201, a position of the vehicle 1201 on the road, or a steering state of the vehicle 1201. That is, the processor 180 may determine a path 1211 and an arrival position 1212 in the lane change by using the velocity of the vehicle 1201, the acceleration of the vehicle 1201, the position of the vehicle 1201 on the road, or the steering state of the vehicle 1201.

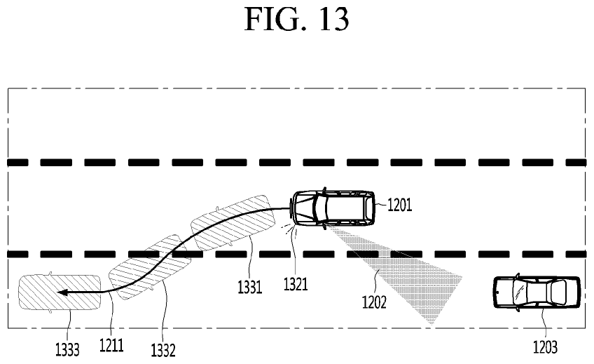

As illustrated in FIG. 13, the processor 180 may control the optical output module 1321 to output the guide images 1331, 1332, and 1333 in the form of an animation along the determined lane-change path 1211.

In other words, the processor 180 may output a vehicle-shaped guide image having the shape and the size of the vehicle 1201 in the form of an animation moving along the lane-change path 1211.

In this case, the guide image animation may be repeatedly output several times during the change of the lane.

The guide image included in the guide image animation is not limited to the vehicle-shaped guide image. For example, the processor 180 may output, through the optical output module, a guide image animation in which an arrow-shaped guide image is moved to emphasize the moving line of the vehicle.

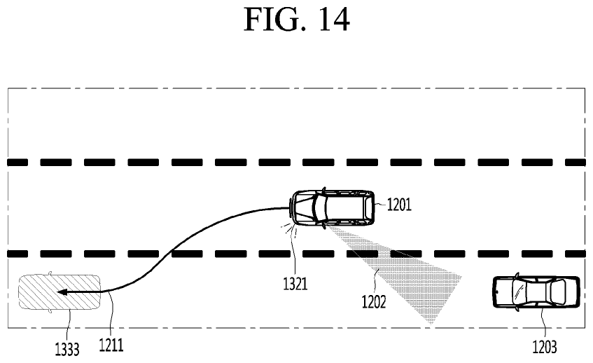

As illustrated in FIG. 14, the processor 180 may output a guide image 1333 to the arrival position 1212, which is determined, by controlling the optical output module 1321.

In other words, the processor 180 may output, at the arrival position 1212, a vehicle-shaped guide image corresponding to the shape and the size of the vehicle 1201, by controlling the optical output module 1321.

The processor 180 may output the optical output module 1321 to output the guide image based on the determined lane-change path 1211 or arrival position 1212 during the lane change of the vehicle 300 1201.

In addition, the processor 180 may update the lane-change path and the arrival position by using the first driving information during the lane change of the vehicle 1201, and may output the guide image based on the updated lane-change or updated arrival position.

In addition, the processor 180 may stop the output of the guide image when the vehicle 1201 terminates the lane-change or the lane-change intention is disappeared.

When the vehicle attempts to change the lane, the guide image is irradiated with light on the lane-change path and at the arrival position. The driver of the external vehicle may clearly recognize the lane-change intention of the vehicle and more rapidly take an action, thereby effectively lower the accident possibility.

According to an embodiment of the present invention, the above-described method may be implemented as a processor-readable code in a medium where a program is recorded. Examples of a processor-readable medium may include read-only memory (ROM), random access memory (RAM), CD-ROM, a magnetic tape, a floppy disk, and an optical data storage device.

What is claimed is:

1. An AI apparatus for providing a notification related to a lane-change of a vehicle, the AI apparatus comprising:
a sensor unit including at least one of an image sensor, a RADAR sensor or a LIDAR sensor; and
a processor configured to:
receive, from the sensor unit, sensor information on a surrounding road and each of at least one external vehicle,
acquire first driving information including a position on the road, a velocity and a steering state with respect to the vehicle using the sensor information,
calculate second driving information including a position, a distance, and a velocity of each of the at least one external vehicle using the sensor information,
determine a lane-change suitability of a lane-change based on the first driving information and the second driving information, and
output a notification related to the lane-change based on the determined lane-change suitability.

2. The AI apparatus of claim 1, wherein the processor is configured to:
calculate an accident possibility for each of the at least one external vehicle in the lane-change, using the first driving information and the second driving information; and
determine the lane-change suitability based on whether the calculated accident possibility exceeds a preset reference value

3. The AI apparatus of claim 2, wherein the processor is configured to:
determine a lane-change path of the vehicle and an arrival position on a lane at a destination, in the lane-change based on the first driving information.

4. The AI apparatus of claim 3, further comprising:
a light output unit capable of adjusting a direction of a projected light and an intensity of the projected light, and
wherein the processor is configured to:
if the lane-change suitability is determined to be suitable, output a guide image for notifying the lane-change on the road corresponding to the lane-change path or the arrival position by controlling the light output unit.

5. The AI apparatus of claim 4, wherein the processor is configured to:
output the guide image at the arrival position or output the guide image in the form of an animation moving along the lane-change path.

6. The AI apparatus of claim 5, wherein the guide image is a vehicle image corresponding to a size of the vehicle and a shape of the vehicle.

7. The AI apparatus of claim 3, wherein the processor is configured to:
determine the lane-change path and the arrival position from the first driving information by using a path predication model which is learned by using a machine learning algorithm or a deep learning algorithm.

8. The AI apparatus of claim 2, further comprising:
a communication unit configured to transmit or receive data from external vehicles,
wherein the processor is configured to:
if the lane-change suitability is determined to be suitable, transmit, through the communication unit, a notification of the lane-change to at least one of adjacent vehicles, which are within a predetermined distance from the vehicle, of the at least one external vehicle.

9. The AI apparatus of claim 2, further comprising:
at least one of a display unit configured to output an image signal; or
a speaker configured to output a sound signal,
wherein the processor is configured to:
if the lane-change suitability is determined to be unsuitable, output, through the display unit or the speaker, a notification that the lane-change is unsuitable to a user.

10. The AI apparatus of claim 1, wherein the processor is configured to:
recognize the at least one external vehicle from the sensor information by using a vehicle recognition model which is learned by using a machine learning algorithm or a deep learning algorithm.

11. The AI apparatus of claim 1, wherein the processor is configured to:
determine a lane-change intention for the vehicle; and
determine the lane-change suitability when the lane-change intention exists.

12. The AI apparatus of claim 11, wherein the processor is configured to:
determine the lane-change intention based on whether a lane-change command is issued by a self-driving control unit which controls a self-driving function.

13. The AI apparatus of claim 11, further comprising:
a camera configured to acquire image data including a face of a driver,
wherein the processor is configured to:
acquire state information of the driver from the image data; and
determine the lane-change intention based on a lighting state of a turn light of the vehicle, a steering state of the vehicle, and the state information of the driver, and
wherein the state information includes:
at least one of information on a head direction of the driver or information on a gaze direction of the driver.

14. A method for providing a notification related to a lane-change of a vehicle, the method comprising:
receiving sensor information on surrounding road and each of at least one external vehicle from at least one of an image sensor, a RADAR sensor or a LIDAR sensor; and
acquiring first driving information including a position on the road, a velocity and a steering state with respect to the vehicle using the sensor information,
determining a lane-change intention with respect to the vehicle;
calculating second driving information including a position, a distance, and a speed with respect to the at least one external vehicle by using the sensor information;
determining a lane-change suitability based on the first driving information and the second driving information; and
outputting a notification related to the lane-change based on the determined lane-change suitability.

15. A recording medium having a program recorded therein to execute a method for providing a notification related to a lane-change of a vehicle,
wherein the method includes:
receiving sensor information on surrounding road and each of at least one external vehicle, from at least one of an image sensor, a RADAR sensor, or a LIDAR sensor;
acquiring first driving information including a position on the road, a velocity and a steering state with respect to the vehicle using the sensor information,
determining a lane-change intention for the vehicle;
calculating second driving information including a position, a distance and a velocity of each of the at least one external vehicle using the sensor information,
determining a lane-change suitability based on the first driving information and the second driving information; and
outputting a notification related to the lane-change based on the determined lane-change suitability.
